(19) United States
(12) Patent Application Publication
(10) Pub. No.: US 2005/0081039 A1
(43) Pub. Date: Apr. 14, 2005

(54) Method for creating and verifying simple object access protocol message in web service security using signature encryption

(76) Inventors: Dae-Ha Lee, Daejeon-city (KR); Chan-Kyu Park, Daejeon-city (KR); Rock-Won Kim, Daejeon-city (KR); Jin-Young Moon, Daegoo-city (KR); Byoung-Youl Song, Daejeon-city (KR); Seung-Woo Jung, Daejeon-city (KR); Hyun-Kyu Cho, Daejeon-city (KR); Ho-Sang Ham, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/750,516

(22) Filed: Dec. 31, 2003

(30) Foreign Application Priority Data
Oct. 10, 2003 (KR) 2003-0070551

(51) Int. Cl. H04L 9/00

(52) U.S. Cl. 713/176

(57) ABSTRACT

Disclosed is a method for creating and verifying SOAP messages in web service security using signature encryption. The SOAP message sender encrypts a signature used for SOAP message security with a secret key for encrypting data to be contained in the SOAP body. The encrypted signature is inserted in the security header of the SOAP header and sent to the recipient. The SOAP message recipient decrypts the encrypted key with his/her private key and restores the secret key. The restored secret key is used to decrypt the encrypted signature in the security header of the SOAP header, and the decrypted signature is used to verify the SOAP message.

### CROSS REFERENCE TO RELATED APPLICATION

This application claims priority to and the benefit of Korea Patent Application No. 2003-70551 filed on Oct. 10, 2003 in the Korean Intellectual Property Office, the content of which is incorporated herein by reference.

### BACKGROUND OF THE INVENTION

(a) Field of the Invention

The present invention relates to web service security. More specifically, the present invention relates to a method for creating and verifying SOAP (Simple Object Access Protocol) messages using signature encryption in web service security that emphasizes SOAP message security.

(b) Description of the Related Art

Generally, web service security places priority on SOAP message security. The term “SOAP” as used herein refers to a protocol that suggests a method for efficiently implementing calls between various components over a network based on XML (extensible Markup Language) and HTTP (HyperText Transfer Protocol) communications. The SOAP is a message-based protocol that only requires a message format negotiated between two systems to be integrated, so it can enhance integration time and efficiency with its simple structure.

The SOAP message security uses digital signatures to prove integrity of data and verify the identity of data, and includes data encryption for secrecy of the data. Furthermore, the secret key used for data encryption is encrypted with a public key of the recipient.

The mechanism of web service security including SOAP message security is designed to support a variety of conventional security models and encryption techniques. This also provides a general mechanism for security tokens. The web service security is designed in the extensible form suitable for different kinds of security tokens rather than a specific security token. Also, this mechanism of web service security specifies how to encode security tokens, especially the encoding method for X.509 certificates and Kerberos tickets, and how to include the encrypted key.

The technique regarding the web service security is disclosed in Korean Patent Publication No. 2003-5675 (“Web module certification device and method”), which technique involves certifying web modules through a certification server prior to the web service and providing the web service only for the certified web modules, thereby increasing security of web modules.

The above-stated techniques are, however, problematic in that digital signatures are susceptible to forgery by a third party who manipulates or alters the digital signatures during the SOAP message transport.

For that reason, there is a need for a program to protect digital signatures against possible forgeries in web service security techniques.

### SUMMARY OF THE INVENTION

It is an advantage of the present invention to provide a method for creating and verifying SOAP messages in web service security using signature encryption, which method transports SOAP messages by encrypting signatures for proving integrity of data and verifying the identity of data in the web service security based on the SOAP message security.

In one aspect of the present invention, there is provided a method for creating a SOAP message in web service security using signature encryption, which method is for a sender's creating a SOAP message that includes a SOAP envelope comprised of a SOAP header including a security header, and a SOAP body, in web service security based on SOAP message security, the method including: (a) creating a timestamp used to protect against reuse of security information of the SOAP message, and a security token serving as information about security of the SOAP message, and inserting the timestamp and the security token in the security header of the SOAP header; (b) encrypting data to be transferred through the SOAP message with a specific secret key to create encrypted data, and inserting the encrypted data in the SOAP body; (c) attaching a digital signature to create a signature, encrypting the created signature with the specific secret key to create an encrypted signature, and inserting the encrypted signature in the security header of the SOAP header, so as to prove integrity of the SOAP message and verify identification; and (d) encrypting the secret key used for encryption of the data and the signature with a public key of a recipient of the SOAP message to create an encrypted key, and inserting the encrypted key in the security header of the SOAP header.

Preferably, the encryption of the data and the signature of the steps (b) and (c) are performed according to a symmetric key encryption algorithm.

Preferably, the encryption of the secret key of the step (d) is performed according to an asymmetric key encryption algorithm.

In another aspect of the present invention, there is provided a method for verifying a SOAP message in web service security using signature encryption, which method is for a recipient's verifying a SOAP message that includes a SOAP envelope comprised of a SOAP header including a security header, and a SOAP body, in web service security based on SOAP message security, the method including: (a) acquiring a certificate for verifying a signature of the SOAP message; (b) decrypting an encrypted key in the security header of the SOAP header with a private key of the recipient to acquire a secret key; (c) decrypting an encrypted signature in the security header of the SOAP header with the acquired secret key, and restoring an original signature; (d) verifying the restored signature of the step (c) using the certificate acquired in the step (a); and (e) decrypting encrypted data in the SOAP body with the secret key of the step (b), and restoring original data.

Preferably, the step (a) includes acquiring the certificate from a security token in the security header of the SOAP header.

Preferably, the decryption of the signature and the encrypted data of the steps (c) and (e) are performed according to a symmetric key encryption algorithm.

Preferably, the decryption of the encrypted key of the step (b) is performed according to an asymmetric key encryption algorithm.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a configuration of a general SOAP message;

FIG. 2 is a block diagram of a mechanism for creating the encrypted key shown in FIG. 1;

FIG. 3 is a flow chart showing a process for creating the SOAP message of FIG. 1;

FIG. 4 is a flow chart showing a process for the recipient's verifying the received SOAP message of FIG. 1;

FIG. 5 is a schematic view showing a process for making a signature forgery on a general SOAP message security;

FIG. 6 is a configuration of a SOAP message in a web service security method using signature encryption according to an embodiment of the present invention;

FIG. 7 is a block diagram of a mechanism for creating the encrypted signature shown in FIG. 6;

FIG. 8 is a flow chart showing a process for creating the SOAP message of FIG. 6; and

FIG. 9 is a flow chart showing a process for a recipient to verify the received SOAP message of FIG. 6.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

Hereinafter, a description will be given in detail as to a web service security method using signature encryption according to an embodiment of the present invention with reference to the accompanying drawings.

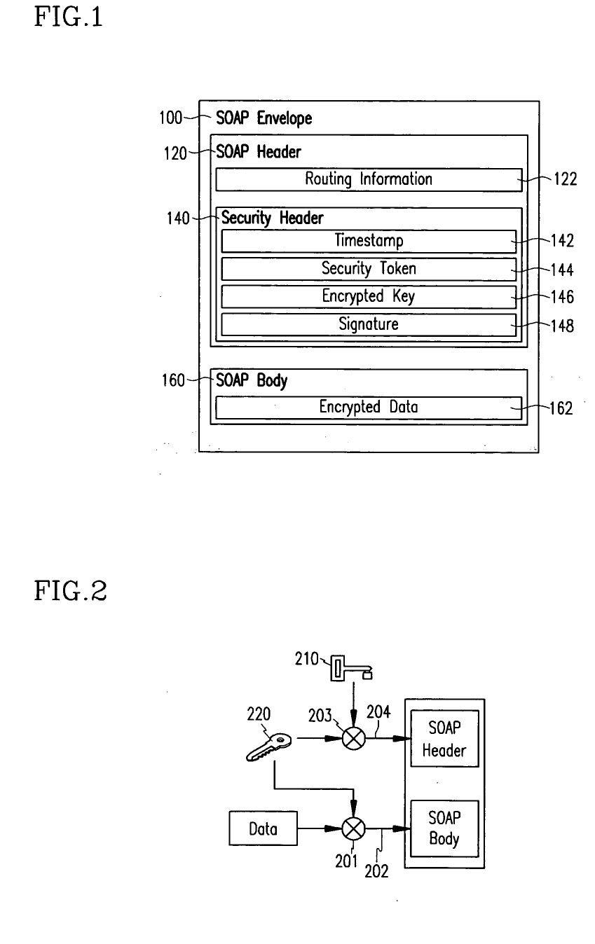

FIG. 1 is a configuration of a general SOAP message.

The SOAP message comprises, as illustrated in FIG. 1, a SOAP envelope 100 that includes a SOAP header 120 having a double data structure, and a SOAP body 160.

The SOAP envelope 100 provides the whole framework for representing information about the content or object of the SOAP message.

The SOAP header 120 includes routing information 122 representing information about the origination and the destination of the SOAP message, and a security header 140 for SOAP security.

The security header 140 includes a timestamp 142, a security token 144, an encrypted key 146, and a signature 148.

The timestamp 142 is used to protect against reuse of security information, and is comprised of the creation time and the expiration date of the security information.

The security token 144 is security-concerning information, and is classified into an unsigned security token and a signed security token. The unsigned security token is a security token not certified by a certification authority and includes information, such as username, that can be applied when the security level is low. The signed security token is a security token certified and cryptologically signed by a certification authority, and includes X.509 certificates or Kerberos tickets.

The encrypted key 146 is a secret key (session key) made by encrypting data located in the SOAP body 160 and encrypted with a public key of the recipient. This is the same concept as the electronic envelope used in the SET (Secure Electronic Transaction) method.

The signature 148 is a signed part of data using an XML digital signature algorithm, and provides integrity of data and the disclaim protecting function.

The SOAP body 160 includes encrypted data 162, which is a part of the SOAP body data encrypted using an XML encryption algorithm, and it provides secrecy of the data.

FIG. 2 is a block diagram of a mechanism for creating the encrypted key 146 of FIG. 1. The encrypted key creating mechanism is a mechanism for encrypting a data-encrypted secret key with a public key of the recipient on the SOAP message security method and securely transporting it.

In this mechanism, the secret key refers to a key used for a symmetric key encryption algorithm. The symmetric key encryption algorithm uses the same key in both encryption and decryption. Hence, the key exchange process is a prerequisite to the encryption/decryption.

The private/public key refers to a key used for the asymmetric encryption algorithm. The asymmetric key encryption algorithm uses a public key for encryption and a private key for decryption. Contrary to the symmetric key encryption algorithm, the asymmetric key encryption algorithm does not require a key exchange process prior to the encryption/decryption. The public key used for encryption is open to the public by the certification authority, and the private key for decryption is possessed by a private person. So, unlike the symmetric key encryption algorithm, the asymmetric key encryption algorithm guarantees no loss of key during the key exchange process.

The session key refers to a key made for use during a defined time period, and is used to protect against reuse of keys. The secret key used for the symmetric encryption algorithm is usually made in the same form as a session key.

The encryption key creating mechanism follows the electronic envelope mechanism in the SET, as shown in FIG. 2. The SOAP body data, generally having a long data content, are encrypted with a secret key (session key) 220 according to a symmetric key encryption algorithm that is rapid in encryption/decryption to create encrypted data 162, in block 201. The encrypted data 162 is inserted in the SOAP body 160, in block 202. The secret key (session key) 220 is encrypted with a public key 210 of the recipient according to an asymmetric key encryption algorithm to create an encrypted key 146 that is a sort of electronic envelope, in block 203. The encrypted key 146 is then inserted in the SOAP header 120, particularly the security header 140, in block 204.

The SOAP message recipient uses its private key to decrypt the encrypted secret key in the encrypted key 146 of the security header 140 to create the secret key (session key) 220, and decrypts the encrypted data of the SOAP body 160 with the secret key (session key) 220 to create SOAP body data.

The secret key (session key), of which the length is not so large, does not take a long time for encryption/decryption using the asymmetric key encryption algorithm. The secret key (session key) is of 64 bits in the DES (Data Encryption Standard) and 40 to 128 bits in the SSL (Secure Sockets Layer).

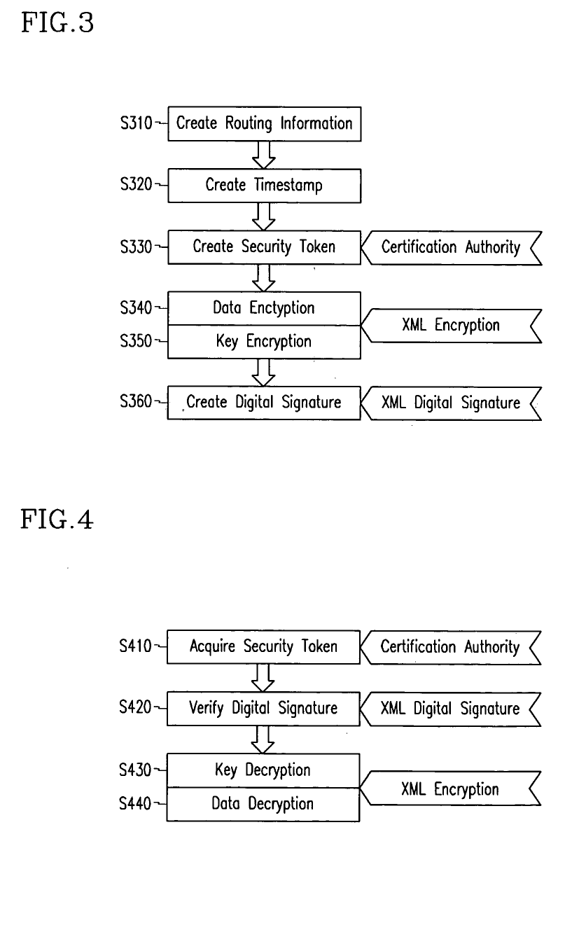

FIG. 3 is a flow chart showing a process for creating the SOAP message of FIG. 1.

Referring to FIG. 1, once data to be carried in the SOAP body 160 are created, routing information for the SOAP message recipient is constructed to create the routing information 122 of the SOAP header 120, in step 310.

The timestamp 142 and the security token 144 of the security header 140 are then created, in steps 320 and 330. When the security token 144 is a signed security token, it can be obtained from a certification authority. If the SOAP body data contains information that is a secret guarded from a third party, then they are encrypted into encrypted data 162, in step 340, and the encrypted data 162 are inserted in the SOAP body 160 to keep the secrecy of the SOAP body data. Here, the encryption process employs the XML encryption algorithm.

The secret key 220 used for data encryption is encrypted with a public key of the recipient to create an encrypted key 146, which is then inserted in the security header 140, in step 350.

Finally, a digital signature is created to prove integrity of data and verify identification, and is inserted in the security header 140, in step 360. The digital signature is created according to an XML digital signature algorithm.

FIG. 4 is a flow chart showing a process for the recipient's verifying the received SOAP message of FIG. 1.

Referring to FIG. 4, to verify the digital signature, the recipient acquires a certificate from the SOAP message header 120 or an external certification authority, in step 410, and verifies the signature 148 of the security header 140 in the SOAP header 140 using the certificate, in step 420.

To decrypt the encrypted data after the verification of the signature, the private key of the recipient is used to decrypt the encrypted key 146 of the header 140 to acquire a secret key 220, in step 430, and the secret key 220 is used to decrypt the encrypted data 162 of the SOAP body 160 to restore the original data, in step 440.

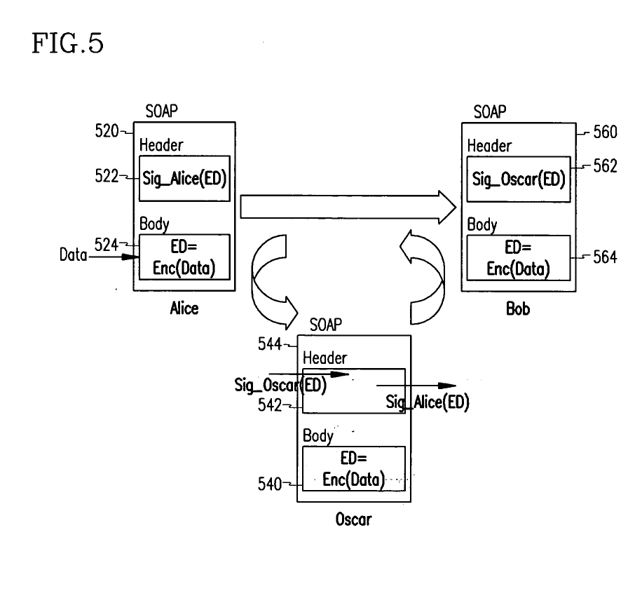

FIG. 5 is a schematic view showing a process for making a signature forgery on a general SOAP message security system.

Referring to FIG. 5, Alice, who is the sender of the SOAP message 520, affixes her signature to encrypted data ED(=Enc(Data)) 524 in the SOAP body 524, and inserts Sig_Alice(ED) 522 in the SOAP header 522 to create a SOAP message 520. The SOAP message 520 thus created is then sent to Bob.

In the meantime, Oscar intercepts the SOAP message 520 sent by Alice on the transmission line of the SOAP message from Alice to Bob, alters the Sig_Alice(ED) 522 signed by Alice to his signature, Sig_Oscar(ED) 544, and sends the modified SOAP message 540 to Bob.

Not knowing that the signature forgery has been carried out by Oscar, Bob regards the received SOAP message 560 as having been signed by Oscar rather than Alice. Therefore, Oscar can disguise himself as the original signer of the data by altering the signature for forgery without decryption of the encrypted data.

As described above, the web service security based on the SOAP message security has a problem in that the third party such as Oscar can intercept the SOAP message to make a signature forgery.

This problem is settled according to the embodiment of the present invention that will be described below.

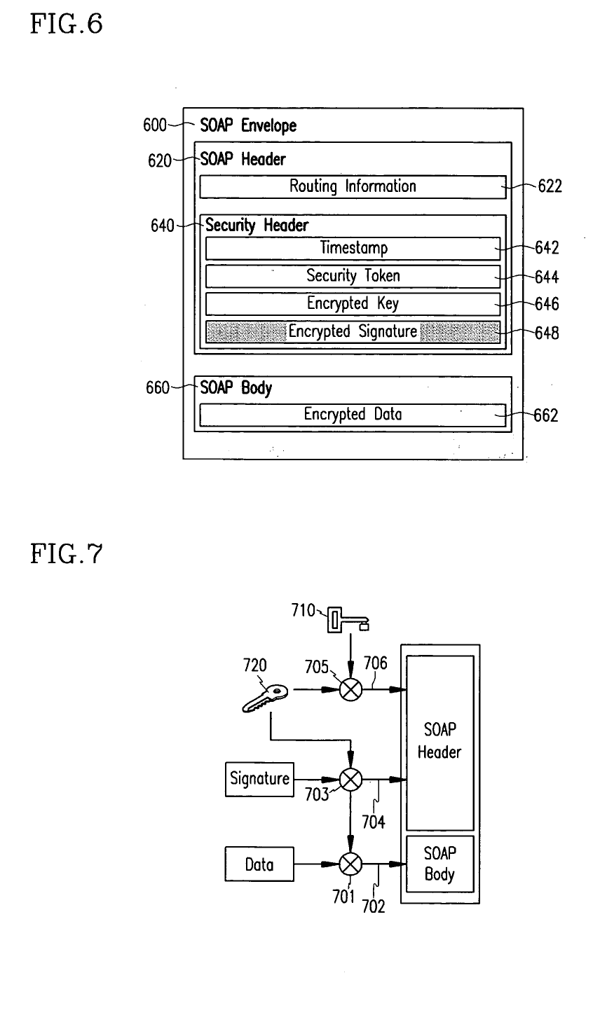

FIG. 6 is a configuration of a SOAP message in a web service security method using signature encryption according to an embodiment of the present invention.

The SOAP message according to the embodiment of the present invention comprises, as illustrated in FIG. 6, a SOAP envelope 600 that includes a SOAP header 620 having a double data structure, and a SOAP body 660.

The SOAP envelope 600 provides the whole framework for representing information about the content or object of the SOAP message. The SOAP header 620 includes routing information 622 representing information about the origination and the destination of the SOAP message, and a security header 640 for SOAP security.

The security header 640 includes a timestamp 642, a security token 644, an encrypted key 646, and an encrypted signature 648.

The timestamp 642, the security token 644 and the encrypted key 646 are the same in structure and function as described in the configuration of the SOAP message with reference to FIG. 1, and will be easily understood by those skilled in the art without a separate description.

The encrypted signature 648 included in the security header 640 is created by encrypting the signed part of the data using an XML digital signature algorithm with a secret key used for encryption of the data according to an asymmetric key encryption algorithm.

The problem of the conventional SOAP message security is that the signature is open to the public irrespective of the secrecy of the data, and is readily altered by a third party. To protect against a signature forgery by alteration of the signature, the signed part of the security header 640 is encrypted into the encrypted signature 648. This deprives the third party from access to the encrypted signature 648 without the secret key and makes signature forgery impossible. However, the recipient can decrypt the SOAP data by performing decryption of the encrypted signature 648 and verification of the signature.

The SOAP body 660 includes encrypted data 662, which is a part of the SOAP body data encrypted using the XML encryption algorithm, and provides secrecy of the data.

FIG. 7 is a block diagram of a mechanism for creating the encrypted signature 648 shown in FIG. 6. The encrypted signature creating mechanism is a mechanism for encryption of signatures with a secret key used for data encryption in the SOAP message security method, and encryption of the secret key used for data and signature encryption with a public key of the recipient, to transfer the secret key securely.

In this mechanism, the secret key refers to a key used for a symmetric key encryption algorithm. The symmetric key encryption algorithm uses the same key in both encryption and decryption. Hence, the key exchange process is a prerequisite to the encryption/decryption process.

As illustrated in FIG. 7, the encrypted signature creating mechanism follows the electronic envelope mechanism in the SET. The digital signature and the SOAP body data are encrypted with a secret key (session key) 720 according to the symmetric key encryption algorithm that is rapid in encryption/decryption to create the encrypted signature 648 and the encrypted data 662, respectively (in blocks 701 and 703). The encrypted signature 648 and the encrypted data 662 are inserted in the SOAP header 640 and the SOAP body 660, respectively (in blocks 702 and 704).

The secret key (session key) 720 used for data and signature encryption is encrypted (in block 705) with a public key 710 of the recipient according to the asymmetric key encryption algorithm to create a sort of electronic envelope, i.e., the encrypted key 646 (in block 705). The encrypted key 646 is then inserted in the security header 640, in block 706.

The SOAP message recipient decrypts the encrypted secret key in an encrypted key 746 of the security header 740 with his/her private key to create the secret key (session key) 720, and then uses the secret key (session key) 720 to decrypt the encrypted signature 648 into the original signature.

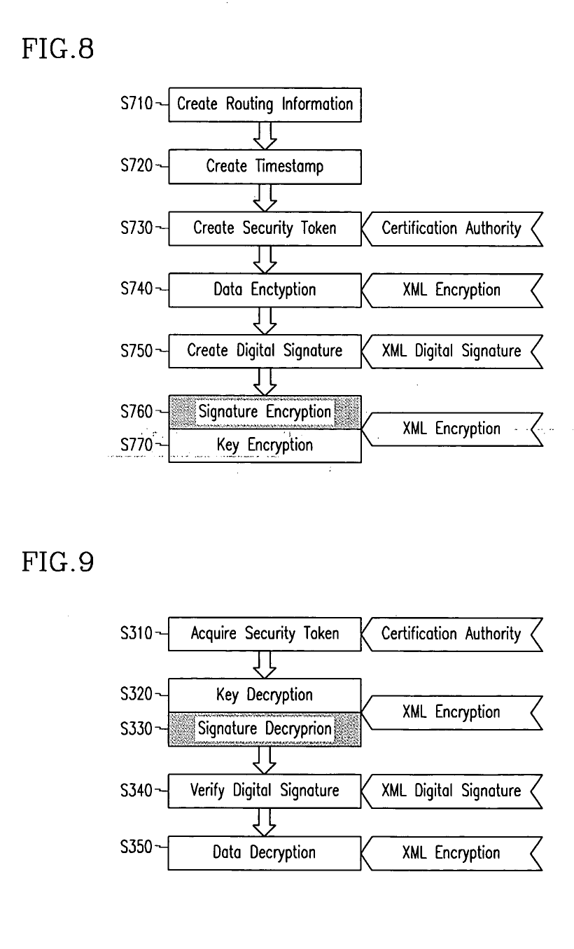

FIG. 8 is a flow chart showing a process for creating the SOAP message of FIG. 6.

Referring to FIG. 8, once data to be carried in the SOAP body 660 are created, routing information for the SOAP message recipient is constructed to create the routing information 622 of the SOAP header 620, in step 710.

The timestamp 642 and the security token 644 of the security header 640 are then created, in steps 720 and 730. When the security token 644 is a signed security token, it can be obtained from a certification authority. If the SOAP body data contains information that is a secret guarded from a third party, then they are encrypted with the secret key 720 to create the encrypted data 662, in step 740, and inserted in the SOAP body 660 to keep the secrecy of the SOAP body data. Here, the encryption process employs the XML encryption algorithm.

To prove integrity of data and verify identification, a digital signature is affixed to create a signature, in step 750. Here, the XML digital signature algorithm is used for the digital signature.

Subsequently, the created signature is encrypted with the secret key 720 used for data encryption to create the encrypted signature 648, in step 760, and the encrypted signature is inserted in the security header 640 of the SOAP header 620, thereby protecting the third party from making a forgery of the signature in the SOAP message. Here, the encryption process employs the XML encryption algorithm.

Finally, the secret key 720 used for data and signature encryption is encrypted with the public key of the recipient to create the encrypted key 646, which is then inserted in the security header 640, in step 770.

FIG. 9 is a flow chart showing a process for the recipient's verifying the received SOAP message of FIG. 6.

Referring to FIG. 9, to verify the digital signature, the recipient acquires a certificate from the SOAP message header 620 or an external certification authority, in step 810.

To decrypt the encrypted digital signature 648, the recipient decrypts the encrypted key 646 of the security header 640 with his/her private key to create the secret key 720, in step 820. This is because the digital signature part of the SOAP message received from the sender is encrypted with the secret key 720.

The recipient decrypts the encrypted signature with the secret key 720 to restore the original signature, in step 830, and verifies the restored signature using the certificate acquired in the step 810, in step 840.

Once the signature is verified, the recipient decrypts the encrypted data 662 of the SOAP body 660 with the secret key 720 already decrypted in the step 820 to restore the original data, in step 850.

The above-described web service security method using signature encryption according to the embodiment of the present invention can be implemented in a program and stored in any computer-readable recording medium (e.g., CD-ROM, RAM, ROM, floppy disk, hard disk, optical magnetic disk, etc.).

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, signature encryption for SOAP messages is performed in the web service based on the SOAP messages to effectively protect against a possible risk of signature forgeries in web service security based on SOAP message security.

1. A method for creating a SOAP (Simple Object-Access Protocol) message in web service security using signature encryption, which method is for a sender's creating a SOAP message that includes a SOAP envelope comprised of a SOAP header including a security header and a SOAP body, in web service security based on SOAP message security, the method comprising:
(a) creating a timestamp used to protect against reuse of security information of the SOAP message, and a security token serving as information about security of the SOAP message, and inserting the timestamp and the security token in the security header of the SOAP header;
(b) encrypting data to be transferred through the SOAP message with a specific secret key to create encrypted data, and inserting the encrypted data in the SOAP body;
(c) attaching a digital signature to create a signature, encrypting the created signature with the specific secret key to create an encrypted signature, and inserting the encrypted signature into the security header of the SOAP header, so as to prove integrity of the SOAP message and verify identification; and
(d) encrypting the secret key used for encryption of the data and the signature with a public key of a recipient of the SOAP message to create an encrypted key, and inserting the encrypted key in the security header of the SOAP header.

2. The method as claimed in claim 1, wherein the data and signature encryptions of the steps (b) and (c) are performed according to a symmetric key encryption algorithm.

3. The method as claimed in claim 1, wherein the encryption of the secret key of the step (d) is performed according to an asymmetric key encryption algorithm.

4. The method as claimed in claim 1, wherein the encryptions of the data, the signature, and the secret key are performed according to an XML (extensible Markup Language) encryption algorithm.

5. A method for verifying a SOAP message in web service security using signature encryption, which method is for a recipient's verifying a SOAP message that includes a SOAP envelope comprised of a SOAP header including a security header, and a SOAP body, in web service security based on SOAP message security, the method comprising:
(a) acquiring a certificate for verifying a signature of the SOAP message;
(b) decrypting an encrypted key in the security header of the SOAP header with a private key of the recipient to acquire a secret key;
(c) decrypting an encrypted signature in the security header of the SOAP header with the acquired secret key, and restoring an original signature;
(d) verifying the restored signature of the step (c) using the certificate acquired in the step (a); and
(e) decrypting encrypted data in the SOAP body with the secret key of the step (b), and restoring original data.

6. The method as claimed in claim 5, wherein the step (a) includes acquiring the certificate from a security token in the security header of the SOAP header.

7. The method as claimed in claim 6, wherein the decryptions of the encrypted signature and encrypted data of the steps (c) and (e) are performed according to a symmetric key encryption algorithm.

8. The method as claimed in claim 6, wherein the decryption of the encrypted key of the step (b) is performed according to an asymmetric key encryption algorithm.

9. The method as claimed in claim 6, wherein the decryptions of the encrypted key, the encrypted signature, and the encrypted data are performed according to an XML (extensible Markup Language) encryption algorithm.

10. A recording medium with a built-in program, which is used in a method for a sender's creating a SOAP message that includes a SOAP envelope comprised of a SOAP header including a security header, and a SOAP body, in web service security based on SOAP message security, the program implementing:
(a) a function of creating a timestamp used to protect against reuse of security information of the SOAP message and a security token serving as information about security of the SOAP message, and inserting the timestamp and the security token in the security header of the SOAP header;
(b) a function of encrypting data to be transferred through the SOAP message with a specific secret key to create encrypted data, and inserting the encrypted data in the SOAP body;
(c) a function of attaching a digital signature to create a signature, encrypting the created signature with the specific secret key to create an encrypted signature, and inserting the encrypted signature in the security header of the SOAP header, so as to prove integrity of the SOAP message and verify identification; and
(d) a function of encrypting the secret key used for encryption of the data and the signature with a public key of a recipient of the SOAP message to create an encrypted key, and inserting the encrypted key in the security header of the SOAP header.

11. A recording medium with a built-in program, which is used in a method for a recipient's verifying a SOAP message that includes a SOAP envelope comprised of a SOAP header including a security header, and a SOAP body, in web service security based on SOAP message security, the program implementing:
(a) acquiring a certificate for verifying a signature of the SOAP message;
(b) decrypting an encrypted key in the security header of the SOAP header with a private key of the recipient to acquire a secret key;
(c) decrypting an encrypted signature in the security header of the SOAP header with the acquired secret key, and restoring an original signature;
(d) verifying the restored signature of the step (c) using the certificate acquired in the step (a); and
(e) decrypting encrypted data in the SOAP body with the secret key of the step (b), and restoring original data.
